(19) United States
(12) Patent Application Publication
(10) Pub. No.: US 2002/0033750 A1
(43) Pub. Date: Mar. 21, 2002

(54) Production method of fine resistor thin film with very low TCR for inkjet printer

(76) Inventors: Munenori Oizumi, Tsukuba (JP); Katsuhiro Aoki, Tsuchiura-shi (JP); Yukio Fukuda, Tokai (JP)

Correspondence Address: TEXAS INSTRUMENTS INCORPORATED, P O BOX 655474, M/S 3999, DALLAS, TX, 75265

(21) Appl. No.: 09/860,864

(22) Filed: May 21, 2001

Related U.S. Application Data
(60) Provisional application No. 60/211,135, filed on Jun. 13, 2000.

(51) Int. Cl. H01C 1/012

(52) U.S. Cl. 338/308

(57) ABSTRACT

A thin film resistor (302) for use in inkjet printer heads that has high resistant and low absolute value of TCR.

### BACKGROUND AND SUMMARY OF THE INVENTION

The present invention relates to thin film resistors and more particularly to thin film resistors with high resistivity and low temperature coefficient of resistance.

### BACKGROUND: THIN FILM RESISTORS IN INKJET PRINTERS

The demand for inkjet printers has steadily increased in recent years due to the growth of the PC market. Recently, the release of high-resolution digital imaging products, such as 2M-pixel digital cameras, has increased the demand for high resolution printing. To meet this demand, inkjet printers are shifting to high resolution printers capable of producing photo-quality prints. Such print quality requires continuing reduction of ink droplet and ink nozzle size. The resolution of current printers is up to 1200-1400 dpi, which corresponds to 17-21 micron per droplet. Yet the demand for higher quality and faster printing speeds calls for even smaller devices.

Thermal inkjet printers generally comprise a printer head mounted on a moveable cartridge which slides back and forth across the width of a page as it prints. The cartridge contains a reservoir for ink. Ink is ejected in controlled patterns during printing via nozzles in the printer head. The nozzles are in fluid communication with the reservoir.

A printer head typically consists of a resistive thin film heating material in contact with a conductor deposited on a thermally and electrically insulated substrate. The conducting layer may be deposited atop the insulating layer first. The conductor is then etched by conventional mask techniques in preparation for the resistor layer, which is deposited next. Alternatively, the resistor layer may be deposited first and etched. The conductive material is then deposited over the resistive material. The individual heating elements are then defined by etching the conducting layer with the usual mask techniques. The resulting configuration allows the heaters to be activated by current applied to the conductors.

Each heating element is positioned beneath an ink chamber with a nozzle that contains the ink to be deposited on the page. The ink chamber and nozzle are formed from resin or polymer material in a separate process and glued to the rest of the printer head. The ink chamber typically communicates with the ink reservoir in the printer cartridge by shared or individual ink feed slots.

Thermal inkjet printers use the heaters to shoot ink droplets onto a page. A microprocessor addresses the resistors via the conducting layer with current pulses according to the patterns to be printed. The current heats the resistors, which in turn vaporize the nearby ink, producing a bubble in the chamber. The growth and collapse of the bubble forces an ink droplet from the nozzle onto the paper surface. The droplets collectively form the printed image.

To meet the requirements for size and speed, the next generation thermal inkjet printers need smaller printer heads. This requires greater resistivity in the heaters to reach the necessary temperatures. Present materials used for thin film resistors can be made to exhibit the required resistivity, but not the necessary stability due to unacceptable temperature coefficient of resistance. Thus, there is a need for thin film resistors with high resistivity and small temperature coefficient of resistance (TCR). Resistivity needs to reach 1000 μΩcm and the absolute value of TCR must remain less than 200 ppm/C.

Improving the TCR is also important for homogeneous heating of the resistor. The temperature at the edge of the heater is often lower than that at the center. If the TCR is large and negative, the resistivity of the center will become smaller than at the edge. This causes more current to flow through the center, further raising the temperature there. This creates a feedback cycle, and the temperature difference between the center and edges becomes very large.

Many materials are known as heater materials, including NiCr, Ta, TiSiN, AlTiN, and TaxN. Among these, TaxN is widely used in thermal inkjet printers because of its high resistivity and stability at high temperatures. For example, commonly used Ta₂N have high resistivity around 180-300 μΩcm, and low TCR of around −100 ppm/C. However, it is hard to raise the resistivity higher, because increasing N, which raises resistivity, also raises TCR.

In order to achieve higher resistivity, Si is often added to TaxN. These films have a large resistivity while maintaining a relatively low TCR. For example, a TaSiN film with around 16% composition ratio Si has resistivity of about 280 μΩcm and TCR of −120 ppm/C. However, increasing the resistivity (to, say, greater than 500 μΩcm) also increases the TCR to unacceptable limits (e.g., TCR>500 ppm/C).

FIG. 1 shows resistivity and TCR of TaSiN films of various Si and N compositions. Silicon content of 0%, 15%, 29%, and 45% are each plotted according to their nitrogen composition ratios. Nitrogen percentages range from 8% to 30%. From FIG. 1 it can be seen that in general, larger N content decreases TCR and increases resistivity, and adding silicon also increases resistivity. However, these compositions have unacceptably large absolute values for TCR.

The rise in TCR is currently considered inevitable and no suggestion for improvement has been reported.

It is therefore an object of the present invention to develop a thin film resistor to act as a heater with large resistivity and small TCR simultaneously.

Production Method of Fine Resistor Thin Film with Very Low TCR for Inkjet Printer

The present application discloses a heater made from TaSiN with large Si composition ratio. The addition of large amounts of Si to the film greatly increases the resistivity, but also increases absolute value of TCR to unacceptable limits. The thin film resistor is therefore heat treated or “pre-operated” as a printer head before actual operation. During this process, the film is heated up to approximately 900 C, substantially the same temperature at which the resistor operates. This drastically reduces the TCR of the thin film, while leaving the resistivity high. This method thus produces thin film resistors with the necessary large resistivity and small TCR.

During production, the TaSiN thin film is deposited by some method (for example, sputtering) onto an insulating layer. In a preferred embodiment, the Si composition ratio of the thin film (Si/(Si+Ta)) is between 40% and 80%, and the N composition ratio is between 2.5% and 50%. Next, the TaSiN thin film is patterned by conventional means, and the rest of the printer head is completed, which includes a conducting layer in electrical contact with the thin film, an ink chamber, and a nozzle. The thin film is heated in a furnace, or by applying current to the conducting layer (and therefore the thin film) in the same manner as in actual printing operations. During this process, the TaSiN film is heated to around 900 C by its own joule heat. This process improves the TCR of the TaSiN film without reducing its high resistivity.

The disclosed innovations, in various embodiments, provide one or more of at least the following advantages:

high resistivity;

low absolute value of TCR;

homogeneous heating of the heater material.

### BRIEF DESCRIPTION OF THE DRAWING

The disclosed inventions will be described with reference to the accompanying drawings, which show important sample embodiments of the invention and which are incorporated in the specification hereof by reference, wherein:

FIG. 1 is a graph showing the resistivity and TCR of TaSiN films with varying composition.

FIG. 2 shows a printer pen that includes a printer head according to the preferred embodiment.

FIG. 3 shows a perspective view of a printer head.

FIG. 4 shows a cross section view of the layers within a printer head.

FIG. 5 shows a cross section view of the layers within a printer head of an alternative design.

FIG. 6 shows the resistivity and TCR of the TaSiN films with large Si composition ratios before and after annealing.

FIG. 7 shows a composition diagram for the innovative thin film resistor material.

FIG. 8 shows a process flow for creation of a printer head substructure employing the preferred embodiment.

### DETAILED DESCRIPTION OF THE PREFERRED EMBODIMENTS

The numerous innovative teachings of the present application will be described with particular reference to the presently preferred embodiment (by way of example, and not of limitation).

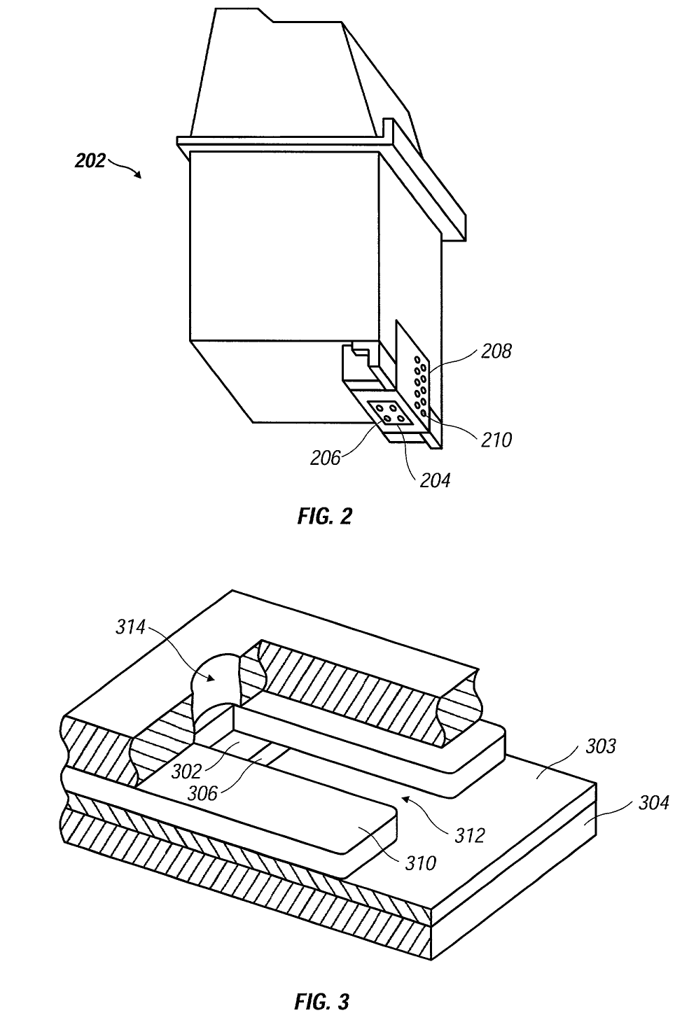

FIG. 2 shows a thermal inkjet printer pen that includes a printer head according to the preferred embodiment. The printer pen includes a pen body 202 that contains a reservoir (not shown). The reservoir contains the ink supply for printing. The pen body 202 contains a printer head 204 on its bottom that is used to control the ejection of ink from the pen. The printer head includes many minute nozzles 206 on its surface that direct ink from firing chambers 308 (shown in FIG. 3) onto the surface of a page. Each firing chamber 308 is positioned beneath or adjacent to a heater made from a thin film resistor 302 that is selectively heated by current pulses to drive ink from the chamber 308 through the nozzle 206 onto the page.

Conducting lines for each thin film resistor component 302 are part of a flexible circuit 208 mounted on the exterior of the pen body 202. Contact pads 210 at the ends of the conducting lines are designed to contact corresponding pads on a matching circuit within the printer carriage. A microprocessor and drivers generate the signals for activating the resistors 302.

FIG. 3 depicts a typical printer head substructure incorporating presently disclosed innovations. A thin film resistor 302 is located on an insulator 303, which covers a substrate material 304. The thin film resistor 302 contacts a conductor 306. The conductor 306 is connected to receive current pulses from a controller or microprocessor (not shown). An ink firing chamber 308 formed out of a barrier material 310 is located above the resistor 302. A channel 312 supplies ink from a reservoir (not shown) to the chamber 308. Current pulses through the conductor 306 generate heat in the resistor 302, which vaporizes ink in the chamber 308, creating a bubble. The expansion and collapse of the bubble ejects an ink droplet through the nozzle 314.

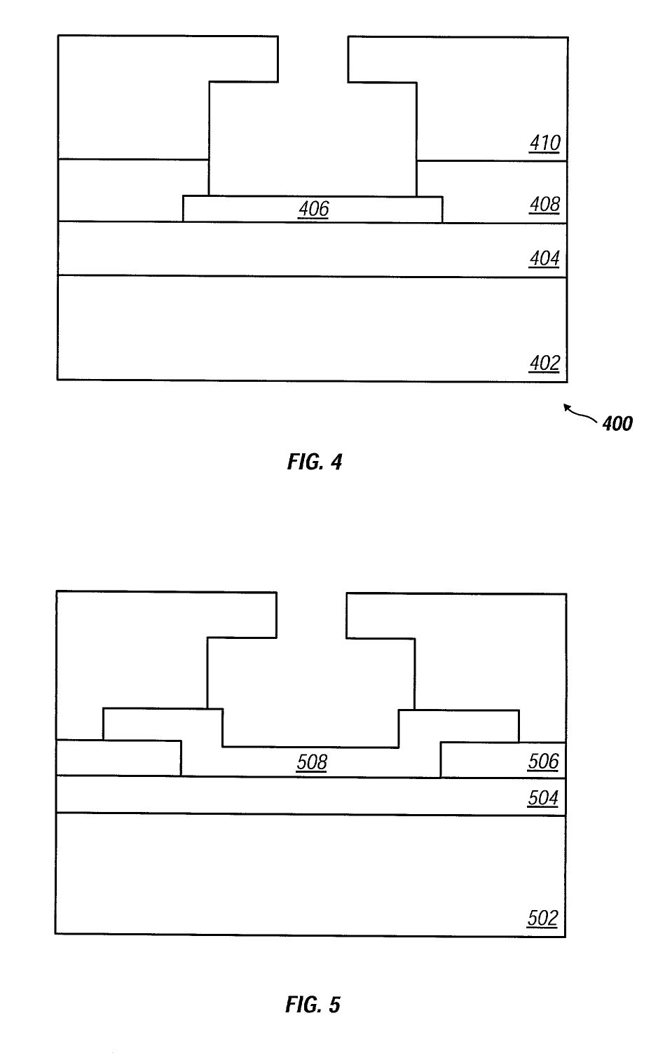

The process of making the innovative printer head 400 is described in FIG. 4. A substrate 402 is covered by an insulating material 404, preferably silicon oxide. The thickness of the insulating layer 404 must be enough to electrically isolate the heater. In the case of a Si substrate and silicon oxide insulating layer, the typical thickness of the insulating layer is several micrometers. A thin film 406 is deposited on the insulating layer 404 by conventional methods, such as RF sputtering. The thickness of the thin film resistor layer 406 depends on the required resistance. Typical thickness ranges from 500-700 Angstroms. The thin film resistor 406 is made from TaSiN, and is deposited using RF-reactive co-sputtering method with Ta and Si targets. In the preferred embodiment, the Si composition ratio, defined as Si/(Si+Ta), is between 40% and 80%. The composition of the Si is adjusted by changing the RF power on each target during deposition. The N composition ratio, defined as N/(N+Si+Ta), is between 2.5% and 50%, and is adjusted by changing the N₂ partial pressure during film deposition.

A first mask layer is used to etch the TaSiN thin film 406 in preparation for the conducting layer 408. The conducting layer 408 is formed using conventional means, and is made from Al (though other metals can also be used). A second mask is needed to pattern the conducting layer 408. Typical thickness for the conducting layer is around 1 micrometer.

Alternatively, the conducting layer can be formed before the thin film resistor is formed, resulting in a slightly different layer configuration as shown in FIG. 5. In such a case, the substrate 502 and insulator 504 remain the same. The conducting layer 506 is formed next, and a mask is used to pattern the conducting layer 506 in preparation for the thin film resistor 508. Regardless of the exact configuration, the conduction layer 506 and the resistor layer 508 must be in electrical contact such that current applied to the conductor 506 generates heat in the resistor 508.

Referring back to FIG. 4, the ink chamber and nozzle 410, composed of resin or polymer material, are fabricated during a separate process and glued to the rest of the printer head substructure 400. This completes assembly of the printer head substructure 400.

The resistivity and TCR of the thin films depend in part on the composition ratios of N and Si in the thin film. Both resistivity and TCR increase as N and Si composition ratios increase. However, adding an annealing step wherein the printer head is heat treated drastically improves the TCR of the annealed thin film. The effect of the annealing depends on the composition ratios of the Si and N. The experimental results discussed below detail the process and results of the heat treatment.

Experimental Results

Films with varying Si and N composition ratios were deposited using RF-reactive co-sputtering method with Ta and Si targets. Composition ratios of Si were adjusted by changing RF power on each target. N composition ratios were adjusted by changing N₂ partial pressure during film deposition. Four different thin film compositions were tried, with Si composition ratios of 60% and 70% each deposited at different N₂ partial pressures of 5.0% and 7.5%. Thermal treatment at 900 C was applied to the films in diluted H₂ ambient for 20 minutes at atmospheric pressure.

The N composition ratio range was determined from the N composition ratios of films deposited in N2 partial pressure of 8%, with varying Si content. The following experimental results were obtained:

| | | | | |
|---|---|---|---|---|
| Si ratio | 0% | 12% | 28% | 45% |
| N ratio | 48% | 53% | 45% | 37% |

These results lead to the conclusion that TaSiN films with Si composition ratios of 60% and 70% deposited in N₂ partial pressures of 5.0% and 7.5% have N composition ratios smaller than 50%. This indicates an N composition ratio range narrower than 0-50%. However, TaSiN with 0% N composition is tantalum silicide, which is quite different from TaSiN, so a lower N composition ratio boundary of 2.5% was used.

FIG. 6 shows the resistivity and TCR of the TaSiN films with large Si composition ratios before and after annealing. In non-heat treated films, resistivity and TCR both increase as N and Si composition ratios increase, making TCR values in films with large resistivity very large. In contrast, the TCR is greatly improved in heat treated films without significant reduction of resistivity. As FIG. 6 shows, the film with 60% Si composition ratio deposited in 7.5% N₂ had large resistivity (2400 μΩcm) after annealing, and the TCR improved drastically from −620 ppm/C to −180 ppm/C. For thin films of 60% Si composition ratio deposited in 5.0% N₂, resistivity was slightly reduced by annealing, and the TCR was raised to a large positive value (400 ppm/C). The change in TCR due to heat treating was greater in films with Si composition ratio of 70%, as shown in the graph. The TCR of these films increased to a large positive value.

Samples with Si values of 16% were also tested. The change in their TCR value was not significant, indicating that the annealing step must be coupled with large Si content in order for the TCR to be reduced significantly by heat treatment. Noting FIG. 6, the TCR of the 60% Si was changed by roughly 400-600 ppm/C (depending in part on the N2 partial pressure at deposition). However, the annealing step affected the 70% Si material more profoundly, changing the TCR by nearly 1000 ppm/C.

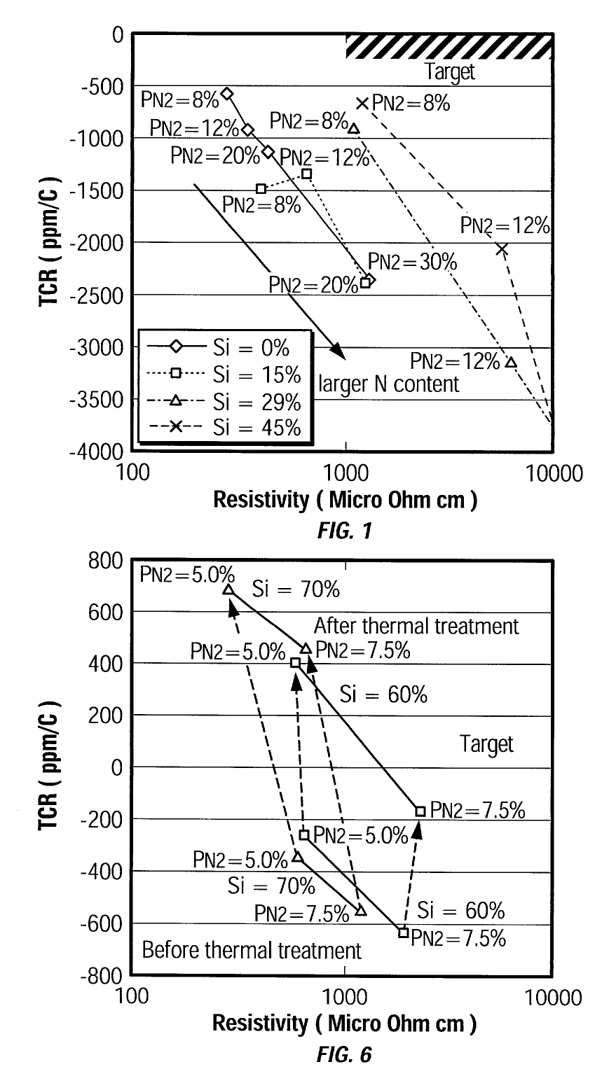

Referring back to FIG. 1, it can be seen that the TCR of TaSiN thin film with fixed Si composition ratios can be gradually reduced by changing N composition. This effect is also seen in FIG. 6, where the films with greater N composition have consistently lower TCR. Specifically, the TaSiN film with 60% Si composition ratio after thermal treatment had a positive TCR (about 400 ppm/C) for N₂ partial pressure of 5.0%, and a negative TCR (about −180 ppm/C) for N₂ partial pressure of 7.5%. Thus, any TCR value between two samples with the same Si composition ratios and different N compositions can be realized by varying the N₂ partial pressure at deposition. This, coupled with the fact that TCR values both above and below zero can be achieved with materials of the same Si content and different N content, indicates that any TCR value near zero can be realized.

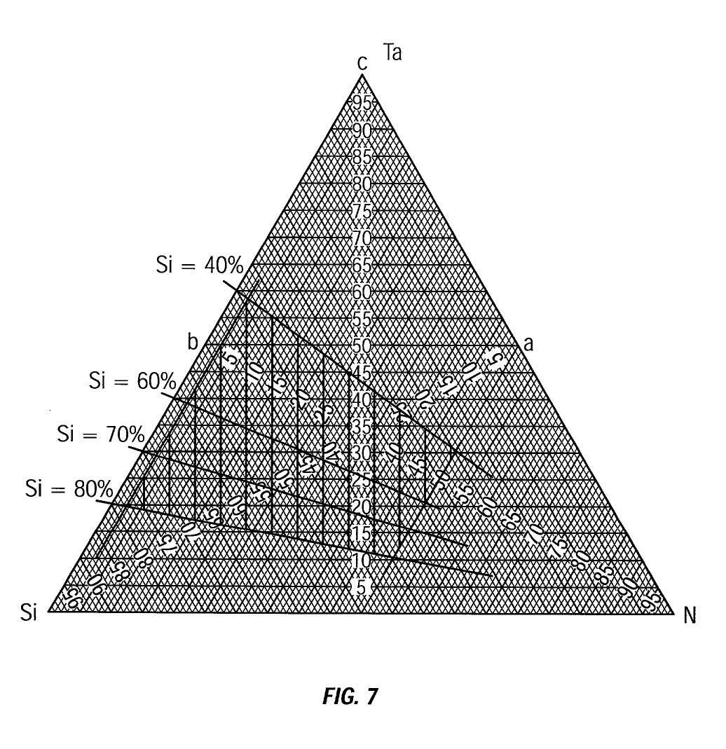

FIG. 7 is a composition diagram for the thin film resistor. The composition ranges of the three materials, Si, Ta, and N, form an area on the graph of acceptable heater material compositions. Si/(Si+Ta) ranges from 40% to 80%, while N ranges from 2.5% to 50%. The crosshatched area shows compositions within the specified ranges. Within this area, the 60% and 70% Si lines are also shown (corresponding with the stated experimental results).

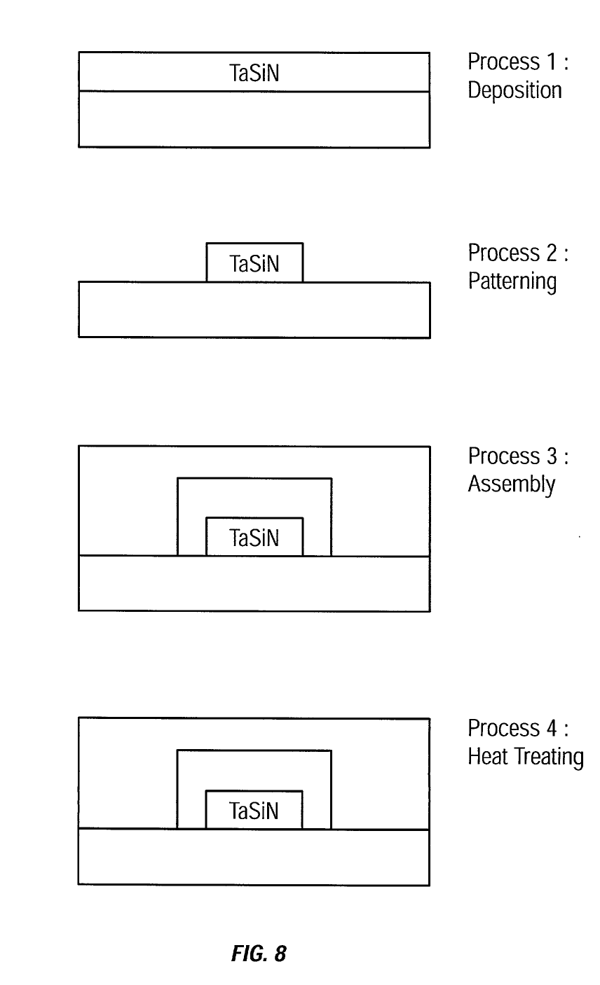

FIG. 8 depicts an overview of the construction process of a printer head employing the preferred embodiment. In process 1, the TaSiN thin film is deposited on a substrate. Process 2 patterns the thin film in preparation for completion of the printer head substructure. In process 3, the other parts of the printer head (including the firing chamber and nozzle) are glued on. In process 4, the completed printer head is run through a dummy printing operation, which causes the thin film to be heated to approximately 900 C by its own joule heat.

Definitions:

Following are short definitions of the usual meanings of some of the technical terms which are used in the present application. (However, those of ordinary skill will recognize whether the context requires a different meaning.) Additional definitions can be found in the standard technical dictionaries and journals.

Composition Ratio: Atomic ratio, or the number of atoms of a given material present in a certain volume. In the present application, the Si percent composition is expressed only in terms of Si and Ta as Si/(Si+Ta). The percent composition of N is defined as N/(N+Si+Ta).

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

Additional general background, which helps to show the knowledge of those skilled in the art regarding variations and implementations, may be found in the following publications, all of which are hereby incorporated by reference: THIN FILM PROCESSES by Vossen, John; Kern (1978); THE SCIENCE AND ENGINEERING OF MICROELECTRONIC FABRICATION by Campbell, Stephen; Oxford Press (1996), PHYSICAL VAPOR DEPOSITION OF THIN FILMS by Mahan, John, 1999; HANDBOOK OF PHYSICAL VAPOR DEPOSITION (PVD) PROCESSING by Mattox, Donald, 1998; HANDBOOK OF SPUTTER DEPOSITION TECHNOLOGY: PRINCIPLES, TECHNOLOGIES, AND APPLICATION by Wasa, Kiyotaka; Hayakawa, Shigeru, 1992.

The material of the resistor can be replaced by a combination of amorphous insulating nitride and crystalline conductive nitride, such as TiSiN, WSiN, HfSiN, NbSiN, MoSiN, and ZrSiN.

Thermal printer heads, which use thin film heaters, can incorporate the presently disclosed innovations which are also applicable to fine resistors used in printed circuits and semiconductor devices.

The heat treating process of the thin film may be replaced by various heating methods, such as heating by laser radiation.

Likewise, other process steps may be varied without deviating from the disclosed innovations, such as varying the composition percentages or materials used to create the thin film, or varying the order or number of process steps used in making the printer head.

The structure of the printer head may be modified. There can be a thin insulating layer on the heater, and the upper part of the printer head (the chamber and nozzle) may be fabricated directly on the lower part using micro-machining technology as is known in the art.

The thin film may be formed i various ways, such as CD sputtering, CD magnetron sputtering, or RF sputtering with one composition target. Or, CVD technology may be used.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

What is claimed is:

1. A resistor with high resistivity and low absolute value of temperature coefficient of resistance, comprising:
a thin film made from a combination of amorphous insulating nitride and crystalline conductive nitride;
wherein said thin film is heat treated to improve temperature coefficient of resistance.

2. The resistor of claim 1, wherein said thin film is TaSiN.

3. The resistor of claim 2, wherein said thin film has Si percent composition of not less than 40% and not greater than 80%.

4. The resistor of claim 2, wherein said thin film has N percent composition of not less than 2.5% and not greater than 50%.

5. The resistor of claim 1, wherein said heat treatment comprises passing current through said thin film.

6. The resistor of claim 1, wherein said thin film is heated to 900 C.

7. The resistor of claim 1, wherein said thin film is heated to substantially near its operating temperature.

8. The resistor of claim 1, wherein said thin film is heated by laser radiation.

9. The resistor of claim 1, wherein said combination is selected from the group consisting of TiSiN, WSiN, HfSiN, NbSiN, MoSiN, and ZrSiN.

10. A thin film resistor, comprising:
a thin film in electrical connection with a conductor, said conductor designed to receive current;
wherein said thin film comprises a combination of amorphous insulating nitride and crystalline conductive nitride; and
wherein said thin film is heat treated to improve TCR.

11. The resistor of claim 10, wherein said thin film comprises TaSiN.

12. The resistor of claim 11, wherein said Si percent composition is not less than 40% and not greater than 80%.

13. The resistor of claim 11, wherein said N content is not less than 2.5% and not greater than 50%.

14. The resistor of claim 10, wherein said thin film is heated to 900 C.

15. The resistor of claim 10, wherein said thin film is heated by applying current to said conductor.

16. The resistor of claim 10, wherein said combination is selected from the group consisting of TiSiN, WSiN, HfSiN, NbSiN, MoSiN, and ZrSiN.

17. A method of producing a thin film resistor, comprising the steps of:
providing a thin film of TaSiN in electrical connection with a conductor;
heat treating said thin film.

18. The method of claim 17, wherein said thin film is heated to substantially near its operating temperature.

19. The method of claim 17, wherein said thin film is heated to 900 C.

20. The method of claim 17, wherein the step of heat treating is done by passing current through said conductor.

21. The method of claim 17, wherein the step of heat treating is done by laser radiation.

22. The method of claim 17, wherein said thin film has Si percent composition of not less than 40% and not greater than 80%.

23. The method of claim 17, wherein said thin film has N percent composition of not less than 2.5% and not greater than 50%.

24. A method of producing a TaSiN thin film resistor, comprising the steps of:
adjusting the Si content of said resistor to a composition ratio of from 40% to 80%;
adjusting the N content of said resistor by varying the N2 partial pressure at deposition;
heat treating said resistor to reduce the absolute value of the temperature coefficient of resistance.
